(19) United States
(12) Patent Application Publication
(10) Pub. No.: US 2015/0118939 A1
(43) Pub. Date: Apr. 30, 2015

(54) PORTABLE GRINDING APPARATUS

(71) Applicant: Powerhouse Mechanical Repair, Inc., Charlotte, NC (US)

(72) Inventors: John VanNess Andrews, JR., Midland, NC (US); Robert Christopher Grice, Charlotte, NC (US); David Graham Kemp, Mt. Holly, NC (US); Mark Andrew Reese, Charlotte, NC (US)

(21) Appl. No.: 14/521,847

(22) Filed: Oct. 23, 2014

Related U.S. Application Data
(60) Provisional application No. 61/895,194, filed on Oct. 24, 2013.

(51) Int. Cl. B24B 23/08; F01D 5/00; B23P 6/00; B24B 19/14

(52) U.S. Cl. CPC B24B 23/08; B24B 19/14; F01D 5/005; B23P 6/002; F05D 2230/10; F05D 2230/80
USPC 451/28; 408/27

(57) ABSTRACT

Embodiments of the invention are directed to a portable grinding apparatus comprising: a frame; a boring bar operatively coupled to the frame; and a grinding assembly operatively coupled to the boring bar, wherein the grinding assembly is adjustable in one or more axes by adjusting the frame or the grinding assembly for grinding a component secured to the frame.

### CROSS REFERENCES TO OTHER RELATED APPLICATIONS

This application claims priority from and is a non-provisional patent application of U.S. Provisional Patent Application No. 61/895,194, filed on Oct. 24, 2013, and entitled “PORTABLE GRINDING APPARATUS,” the contents of which are hereby incorporated by reference in their entirety.

### BACKGROUND

Repairing equipment on site reduces costs and improves efficiency.

### BRIEF SUMMARY

Embodiments of the invention relate to a portable grinding apparatus that may be positioned along the centerline of a turbine (e.g., a turbine power system, a turbine engine, or the like) or any other type of rotational machinery. Once the portable grinding apparatus is positioned along the centerline of the machinery, the portable grinding apparatus may be moveable in one or more axes (e.g., X, Y, and Z) to grind or cut various components. The portable grinding apparatus may be utilized to repair damaged or worn equipment components on site without having to send components to off-site for repair or replacement machining. Particularly, in one embodiment the portable grinding apparatus may be utilized to grind components of a turbine such as seal faces, fits, split lines, surfaces, housings, casings, journals, or like turbine components, or components of other machinery. By repairing equipment onsite, the equipment owner may save both time and money as opposed to shipping large equipment offsite for customized repairs. The present invention uniquely has the ability to perform highly accurate grindings, borings, finishings, or other machining operations in repairing a wide variety of types and sizes of equipment.

In one aspect, the present invention is directed to a portable grinding apparatus comprising: a frame, a boring bar operatively coupled to the frame; and a grinding assembly operatively coupled to the boring bar, wherein the grinding assembly is adjustable in one or more axes by adjusting the frame or the grinding assembly for grinding a component secured to the frame.

In some embodiments, the frame comprises a plurality of cross members that are substantially parallel to one another.

In some embodiments, the cross members are steel I-beams.

In some embodiments, the frame comprises adjustable feet.

In some embodiments, the frame comprises a boring bar bearing fixture wherein the boring bar bearing feature is configured to receive the boring bar via a hole.

In some embodiments, the frame comprises a plurality of collars that enable adjustment of the boring bar bearing feature along the cross member.

In some embodiments, the boring bar is rotatable.

In some embodiments, the rotation of the boring bar is driven by at least one of a hydraulic motor, an electric motor, an air powered motor, computer numerical controls (CNC), or a manual drive.

In some embodiments, the grinding assembly comprises a bar clamp that couples the grinding assembly to the boring bar and enables adjustability of the grinding assembly along the axis of the boring bar.

In some embodiments, the grinding assembly is axially adjustable via a grinding machine clamp that couples the grinding assembly to the bar clamp.

In some embodiments, the grinding assembly includes an adjustable drive shaft.

In some embodiments, the grinding assembly includes a counterweight.

In some embodiments, the grinding assembly includes at least one right angle gear drive.

In some embodiments, the grinding assembly includes a grinding stone arbor.

In some embodiments, the grinding assembly includes a grinding stone.

In some embodiments, the grinding stone includes live tooling.

In some embodiments, the grinding stone is driven by at least one of a hydraulic motor, an air powered motor, an electric motor, computer numerical controls (CNC), or a manual drive.

In some embodiments, the adjustments of the apparatus are powered by at least one of a hydraulic motor, an air powered motor, computer numerical controls, a manual drive, an electric motor, or electronic linear or rotary measuring equipment.

In some embodiments, the grinding assembly is coupled to the boring bar via a keyed sleeve.

In some embodiments, the grinding assembly includes a standard clamp compound assembly.

In some embodiments, the standard clamp compound assembly is axially adjustable via an axial compound feed system.

In some embodiments, the grinding assembly is configured linearly.

In some embodiments, the grinding assembly is configured at a right angle.

In some embodiments, a method of grinding a piece of rotary machinery is provided. The method comprises: mounting the frame of the present invention onto a piece of rotary machinery; operatively coupling the frame to the piece of rotary machinery via a plurality of adjustable feet coupled to each cross member; positioning and securing the grinding assembly along the boring bar via the bar clamp; positioning and securing the grinding assembly along the drive shaft sleeve via the grinding machine clamp and the radial compound advance; positioning and securing the counterweight to ensure proper balance for the specific grinding operation; powering the grinding stone via a motor, which may be electrically, hydraulically, computer-controlled air powered, or manually powered; rotating the boring bar via a motor or a manual drive so that the grinding assembly rotates; and grinding the piece of rotary machinery via the grinding stone.

### BRIEF DESCRIPTION OF THE DRAWINGS

Having thus described embodiments of the invention in general terms, reference will now be made to the accompanying drawings, where:

FIG. 1A illustrates a perspective view of a portable grinding apparatus with a straight grinding assembly mounted in the middle of a boring bar, in accordance with embodiments of the present invention;

FIG. 1B illustrates a perspective view of a portable grinding apparatus with a straight grinding assembly mounted in an end of a boring bar, in accordance with embodiments of the present invention;

FIG. 2 illustrates a perspective view of a portable grinding apparatus with a right-angled grinding assembly, in accordance with one embodiment of the present invention;

FIG. 3 illustrates a perspective view of a portable grinding apparatus installed in a section of rotational machinery, in accordance with embodiments of the present invention;

FIG. 4A illustrates a perspective front view of a portion of a frame of a portable grinding apparatus, in accordance with embodiments of the present invention;

FIG. 4B illustrates a front view of a portable grinding apparatus, in accordance with embodiments of the present invention;

FIG. 4C illustrates a side view of a portable grinding apparatus, in accordance with embodiments of the present invention;

FIG. 4D illustrates a top view of a portable grinding apparatus, in accordance with embodiments of the present invention;

FIG. 5 illustrates a perspective view of a straight grinding assembly, in accordance with embodiments of the present invention;

FIG. 6 illustrates a perspective view of a straight grinding assembly, in accordance with embodiments of the present invention;

FIG. 7 illustrates a perspective view of a right-angled grinding assembly, in accordance with embodiments of the present invention; and

FIG. 8 illustrates a process flow for executing a grinding operation, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

A “user” as used herein may operate the present invention. The user may be defined as any person interacting with the present invention and may refer to a machinist, an engineer, an operator, or the like.

Over time with general use, machine upsets, normal wear and tear from steam or process fluids (e.g., an oil or lubricant), or the like, components (e.g., a seal, a seal face, a fit, a journal, or the like) of large rotating equipment, such as a turbine in a power generation facility, a turbine engine, or another rotary machine used in another industry may wear, become dislodged, damaged, or otherwise require replacement or repair. For example, an oil seal face (e.g., an inside surface) in a turbine housing may become damaged over time and thus may need to be replaced, repaired, or refinished.

When the components of equipment fail, equipment owners may either choose to purchase new components or repair the existing components. Because the components are often large and expensive it may be costly to replace the components, and thus many equipment owners choose to repair the existing components. The equipment downtime, during which components of the equipment are being repaired, may be expensive (e.g., equipment owner downtime cost can approach or exceed one million dollars per day) and as such equipment owners want components replaced or repaired as quickly as possible. Component repair or replacement often results in having to ship large components offsite for customized machining repairs, which may result in large shipping costs and equipment downtime. As described herein, the present invention uniquely provides the equipment owner with a cost-effective system for repairing existing equipment onsite.

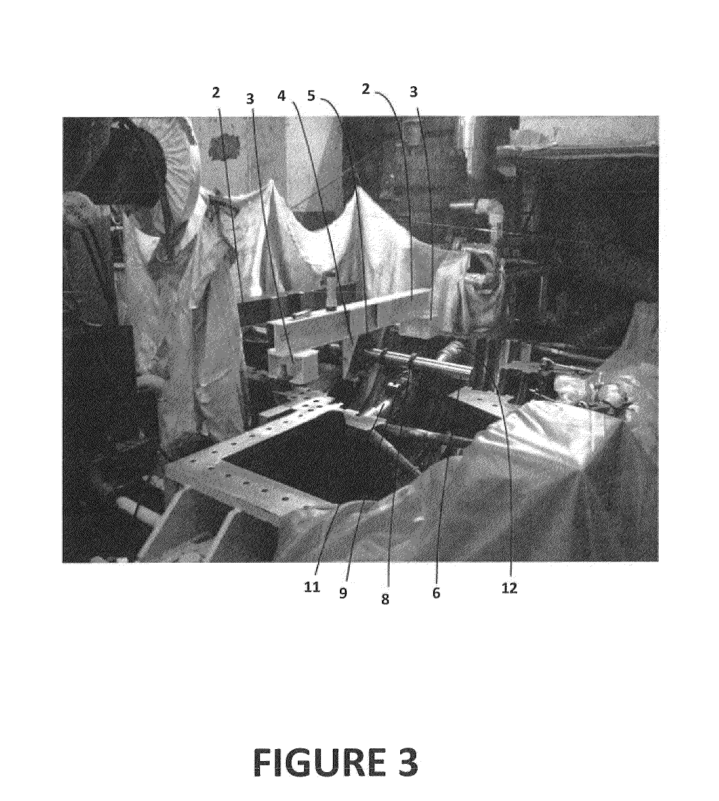

The present invention is a portable grinding apparatus (e.g., a portable seal face grinding apparatus) that is generally used to make circular or semi-circular cuts in a component, but otherwise may be adapted to machine parts in a number of various ways. The present invention has the unique ability to perform highly accurate grindings, borings, finishings, or other machining operations in repairing a wide variety of types and sizes of equipment, including seal faces, fits, split lines, surfaces, housings, casings, journals, or the like. The portable grinding apparatus may be constructed from a combination of components manufactured from steel, iron, aluminum, a composite material, or the like. One example of the portable grinding apparatus in practice is illustrated in the photograph in FIG. 3.

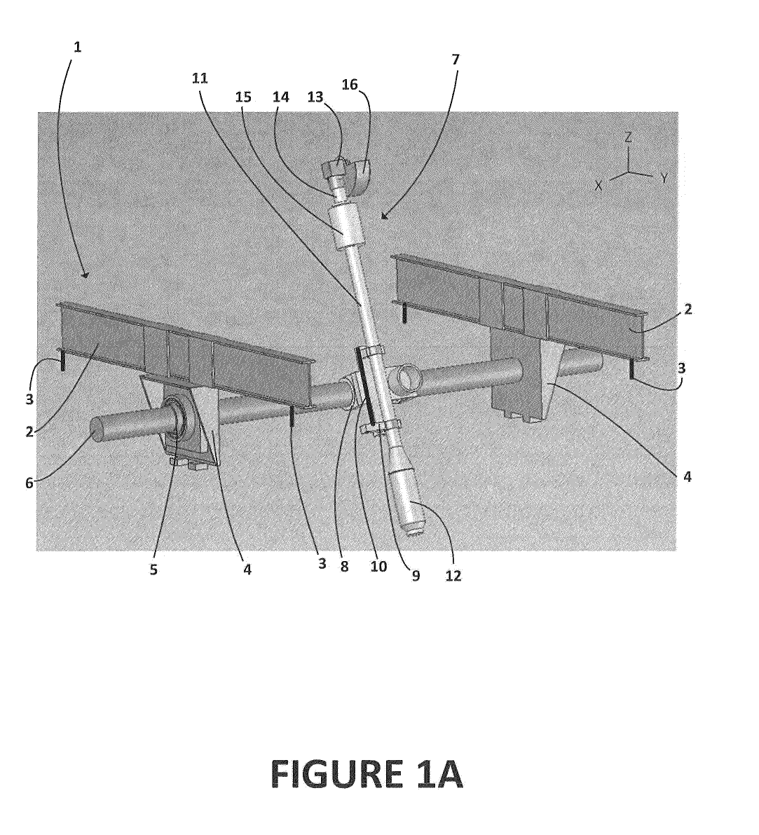

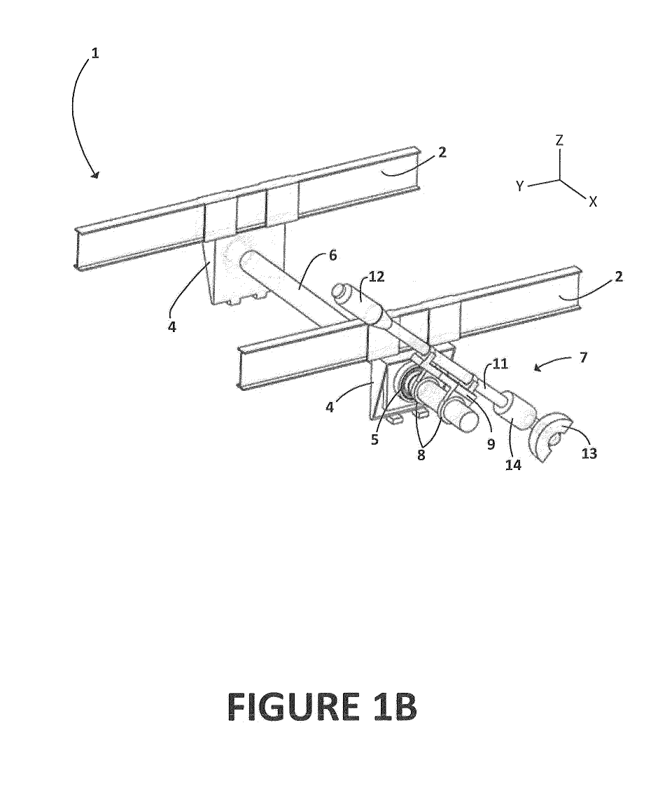

A frame 1 for a portable grinding apparatus may be provided and is depicted in FIGS. 1A, 1B, 2, and 4A through 4D. The frame 1 may include at least one cross member 2. Typically, the frame 1 includes two steel I-beam cross members 2 that are substantially parallel to one another and spaced apart at a predetermined distance. A plurality of cross members 2 may enable the present invention to be placed or positioned on top of an equipment housing or similar component for a grinding or cutting operation. Cross members 2 may further include adjustable cross member feet 3 that can be operatively coupled to the flanges on the rotational machinery so as to position a boring bar 6 along the centerline of the rotational machinery, a configuration depicted in FIGS. 1A through 3. 4C, and 4D. In other embodiments the cross member feet 3 may be operatively coupled to the rotational machinery in other ways to ensure the desired orientation of the boring bar 6. The cross member feet 3 (or the cross members 2 themselves) may be operatively coupled to the rotational machinery through the use of screws, pins, clamps, or the like.

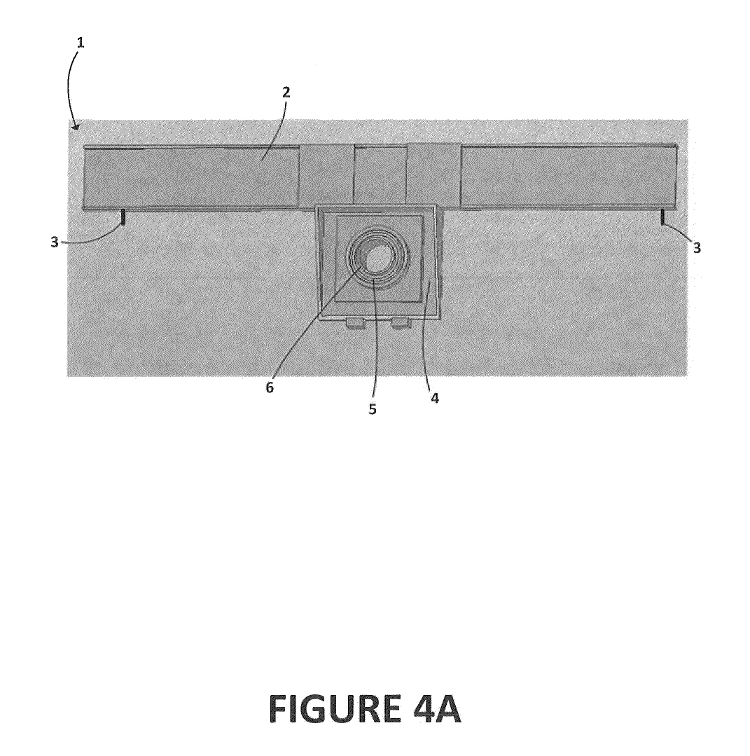

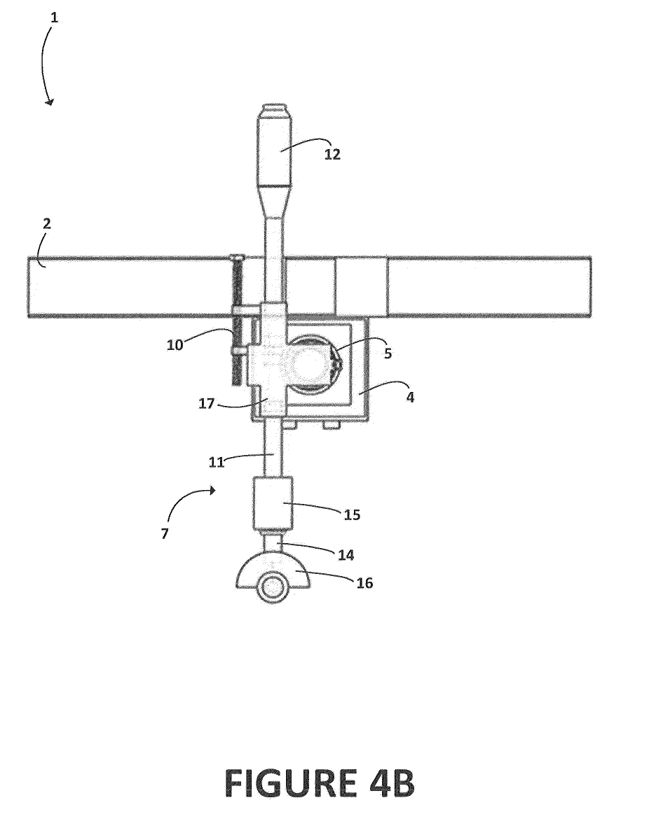

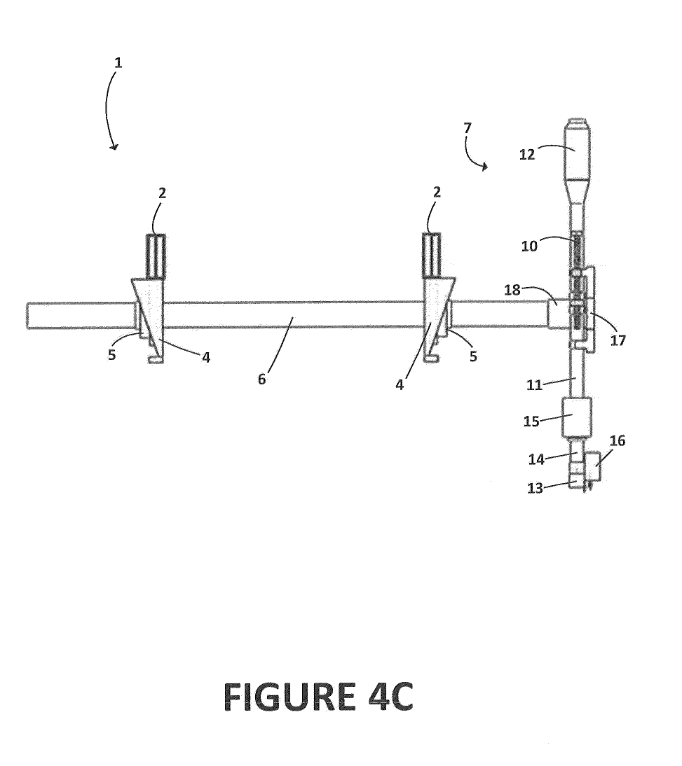

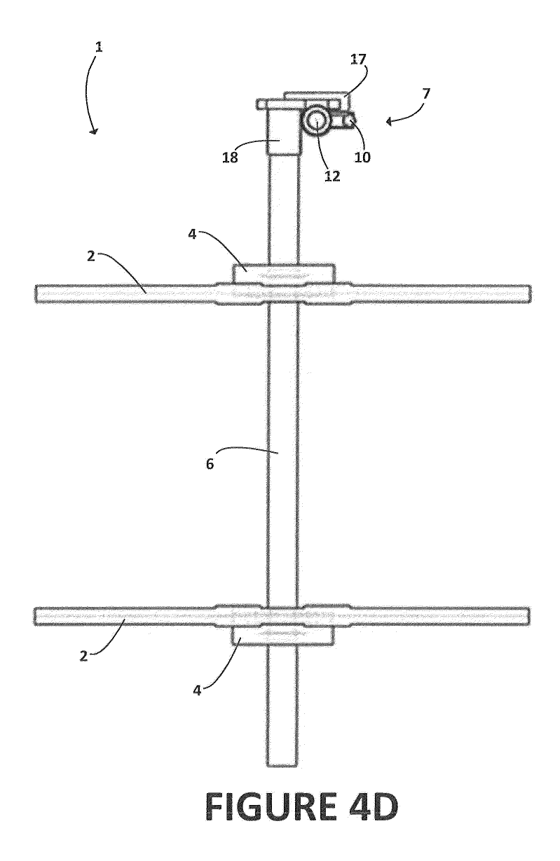

Coupled to each of the cross members 2 may be a boring bar support 4. The boring bar support 4 may be constructed out of steel and may be operatively coupled, either permanently (e.g., a weld) or detachedly, to each of the cross members 2. In the illustrated embodiment of FIG. 4A the boring bar support 4 is permanently operatively coupled to the cross members 2. However, in some embodiment each boring bar support 4 may be adjustably operatively coupled to the cross member 2 so that each boring bar support 4 and each cross member 2 may move with respect to each other. For example, each boring bar support 4 may be adjusted along each cross member 2 in the Y-direction. In alternative embodiments, a coupling such as a screw, a pin, a bolt, or the like may be used to secure the boring bar support 4 to the cross member 2 once the desired position of the boring bar support 4 is selected along the cross member 2.

Furthermore, each boring bar support 4 may include a surface that extends orthogonally to the cross member 2 (e.g., extending downward in the Z-direction when installed). This surface may include an aperture (e.g., a through-hole or other opening) that is configured to receive and/or support a substantially horizontal boring bar 6. The boring bar 6 may be a solid or hollow cylindrical steel rod whose center axis runs along the X-direction of the rotational machinery as shown in FIGS. 1A through 3, 4C, and 4D. The boring bar 6 may be operatively coupled to the boring bar support 4 via the aperture in the substantially vertical surface extension. The boring bar support 4 in some embodiments may comprise a collar and bearings 5 that allow the boring bar 6 to rotate within the boring bar support 4. In some embodiments, each cross member 2 (and thus boring bar support 4 coupled thereto) may be adjustable along the rotational machinery in the X-direction to allow coupling of the portable grinding machine to the rotational machinery. The boring bar 6, in some embodiments may also be moveable in the X-direction within the aperture of the boring bar support 4 in order to position the grinder in the desired location during machining.

The purpose of the boring bar 6 may be to rotate so that a grinding assembly 7 may efficiently grind or cut into a component of equipment. In some embodiments, the boring bar's 6 rotations may be driven by a variable speed motor or drive, a computer, computer numerical controls (CNC), a hydraulic drive, an air powered drive, or the like. In other embodiments, the boring bar 6 may be manually driven or rotated to machine the desired surfaces within the rotational machinery.

The grinding assembly 7 may be operatively coupled to the boring bar 6, for example through the use of a bar clamp 8 in the illustrated embodiments of FIGS. 1A, 1B, and 3. The bar clamp 8 may include one or more collars with apertures therethrough that receive the boring bar 6 to operatively couple a grinding assembly 7 to the boring bar 6. Typically, the one or more collars of the bar clamp 8 are tightened around the boring bar 6 to secure the grinding assembly 7 to the boring bar 6. Couplings, such as bolts, clamps, pins, or the like may be used to secure the bar clamp 8 to the boring bar 6. In some embodiments, the bar clamp 8 may be adjustable along the length of the boring bar 6 in the X-direction. The grinding assembly 7 may be positioned and secured to the boring bar 6 between two I-beam cross members 2 (see FIGS. 1A and 3) or, in other embodiments, the grinding assembly 7 may be positioned and secured to one end of the boring bar 6 outside of the I-beam cross members 2 (see FIGS. 1B, 2, and 4B through 4D).

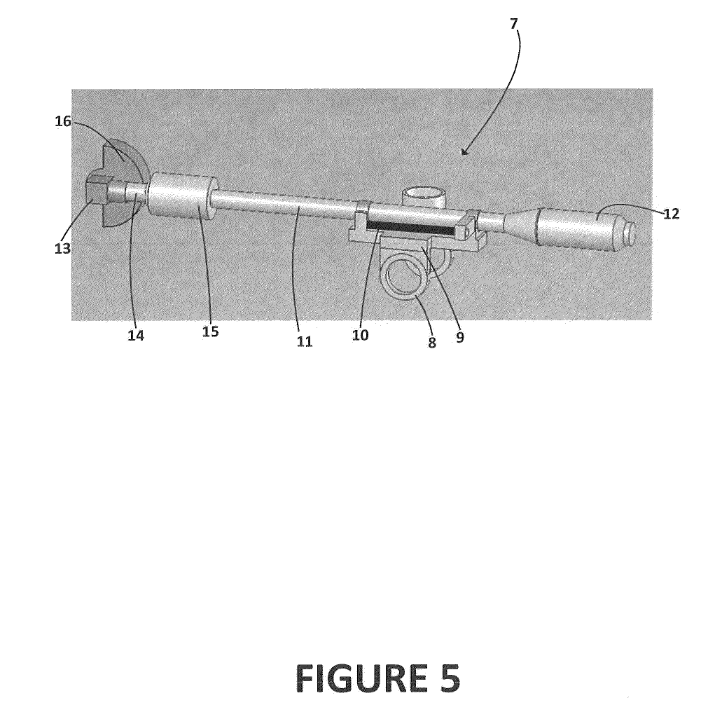

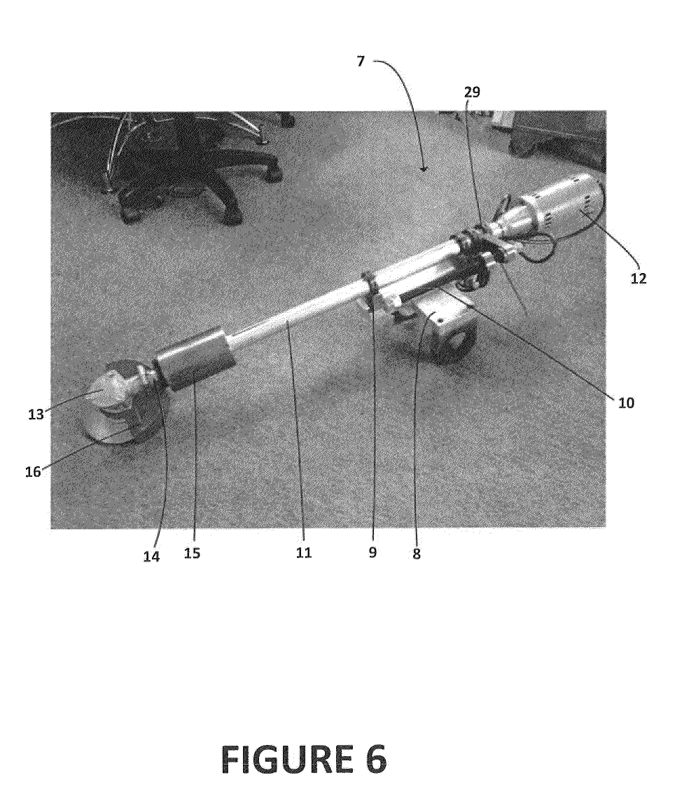

As depicted in FIGS. 1A, 1B, 3, 5, and 6 the grinding assembly 7 may include a grinding machine clamp 9 that secures the grinding assembly 7 to the bar clamp 8. The grinding machine clamp 9 may also include a plurality of collars with an aperture therethrough that are configured to receive a drive shaft sleeve 11. The grinding machine clamp 9 may enable the grinding assembly 7 to be adjusted axially (e.g., in the Y- and Z-directions) via a radial compound advance 10. The radial compound advance 10 may include a threaded rod along which the grinding machine clamp 9 (and thus the drive shaft sleeve 11) may be adjusted in the Y- and Z-directions. The grinding machine clamp 9 may include an advance hole that receives the radial compound advance 10. Essentially, the radial compound advance 10 may be adjusted to enable movement of the grinding machine clamp 9 with respect to a fixed clamp 29 on the drive shaft sleeve 11. Thus, the grinding assembly 9 is adjustable to machine components of the rotational machine within a wide range of diameters or sizes.

The drive shaft sleeve 11 may be a solid or hollow cylindrical bar that typically runs orthogonally to the boring bar 6 (e.g., in the Y-Z plane). During operation, the drive shaft sleeve 11 may rotate in conjunction with the boring bar 6. The purpose of the drive shaft sleeve 11 may be to ensure stability while providing a keyway for a drive and a compound assembly. Essentially, the drive shaft sleeve 11 may serve as a supportive housing for a drive shaft that connects a tool head or a grinding stone to a motor 12.

As illustrated in FIGS. 1A through 6 the motor 12 may be operatively coupled to one end of the drive shaft sleeve 11. The motor 12 may turn a drive shaft that extends throughout the grinding assembly 7 (e.g., through the drive shaft sleeve 11 and/or other components of the grinding assembly 7). In some embodiments, the motor 12 may be driven by direct current (DC) power, a hydraulic drive, an air powered drive, an electrical drive, a manual drive, computer numerical controls (CNC), or another drive. The motor 12 may be variable in speed or power so that an operator may grind or cut a component with the speed and accuracy needed for precise machining of a specific component.

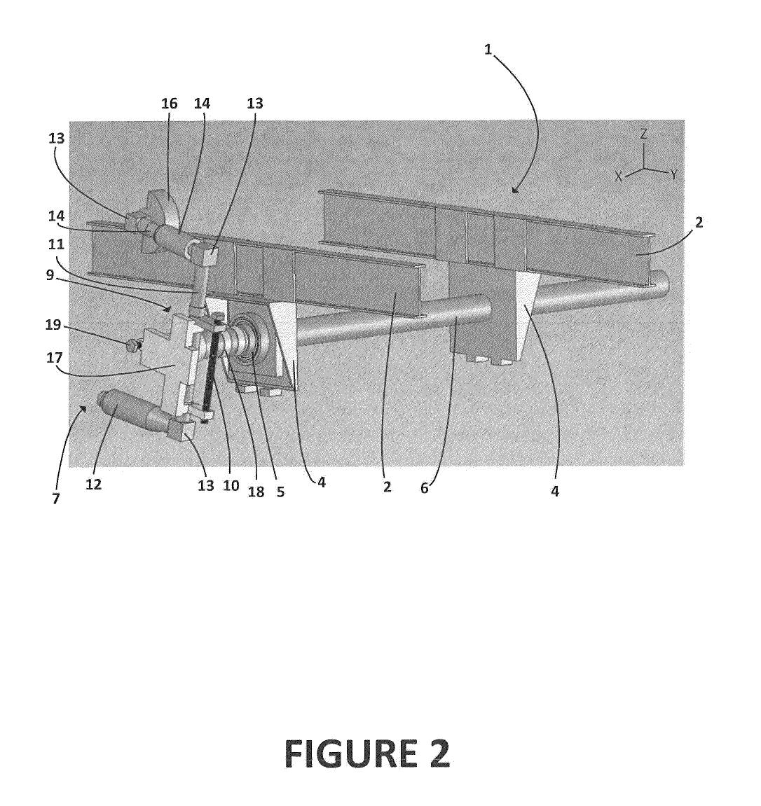

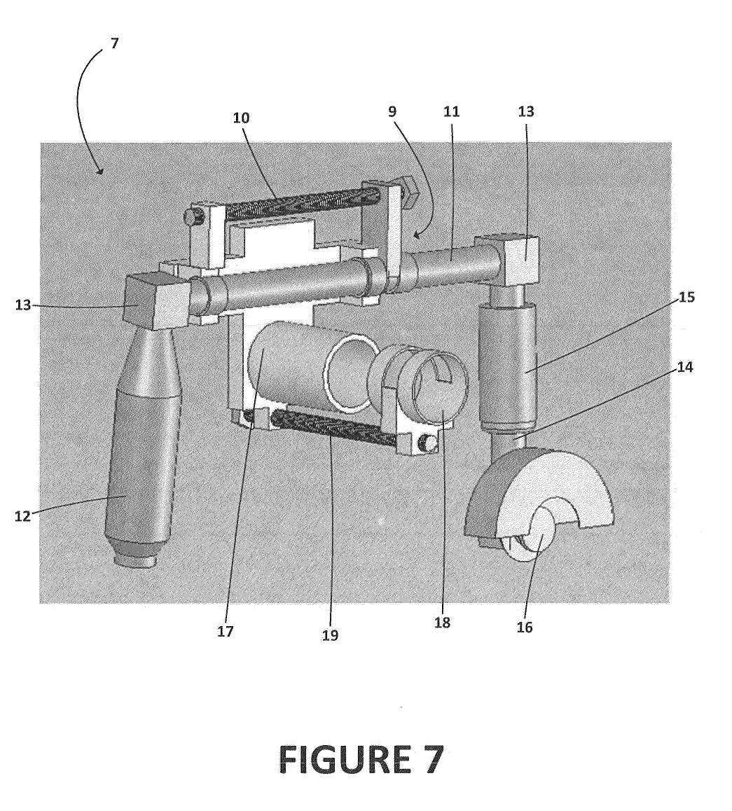

In some embodiments, as illustrated in FIGS. 2 and 7, the motor 12 may be coupled to the drive shaft sleeve 11 at a right angle using a right angle gear drive 13. This right angle gear drive 13 may better orient the motor for grinding applications that require a tighter clearance. In other embodiments, multiple right angle gear drives 13 may be included in the grinding assembly 7, such as at the operative connection between the shaft sleeve 11 and an adjustable length drive shaft 14 and a grinding stone arbor 16. The right angle gear drive 13 may ensure that the proper angle can be obtained to grind the surface to be cut. In alternative embodiments, the right angle gear drive 13 may be adjustable so that a wide range of grinding or cutting angles may be achieved.

In some embodiments, the adjustable length drive shaft 14 is operatively coupled to the drive shaft sleeve 11. The adjustable length drive shaft 14 may enable the grinding assembly to extend outwards or retract into itself when adjusting for a specifically dimensioned grind or cut. The adjustable length drive shaft 14 may be operatively coupled to the drive shaft that extends throughout the grinding assembly and is driven by the motor 12. The adjustable length drive shaft 14 may be constructed from a core of square, hex, or spline and may enable the grinding assembly 7 to grind or cut a wide variety of differently-sized components.

A counterweight 15, illustrated in Figures lA through 2, 4B, 4C, and 5 through 7, may be permanently or detachedly coupled to one end of the drive shaft sleeve 11 for balancing purposes (e.g., to balance with the weight of the motor 12 and the drive shaft sleeve 11). The position of the counterweight 15 may be adjusted along the drive shaft sleeve 11 depending, in part, on the position of the bar clamp 9 on the drive shaft sleeve 11. Furthermore, the counterweight 15 may vary in weight and may include a system for increasing or decreasing weight. The counterweight 15 may ensure that the grinding assembly 7 rotates at an even rate during operation.

The grinding stone arbor 16, a component that holds a grinding stone (e.g., a blade or another cutting tool used for grinding or machining), may be operatively coupled to the drive shaft sleeve 11, the adjustable length drive shaft 14, or a right angle gear drive 13, as well as the drive shaft. The grinding stone arbor 16 may include a shroud or another type of protective shield to minimize the spray of debris during operation. In some embodiments, live rotary tooling components such as but not limited to collet style, R30, R40, R50, or other types of cutting tools may be used in lieu of the grinding stone. Live rotary tooling may include adjustability along the X-, Y-, and Z-axes within the center line of the rotating machinery, which may enable the present invention to make specific types of cuts with high accuracy (typically within a precision range of a thousandth of an inch or less).

The grinding assembly 7 may also be positioned on one end of the boring bar 6 using a standard clamp compound assembly 17, as illustrated in FIGS. 2 4B through 4D, and 7. The standard clamp compound assembly 17 may be coupled to the boring bar 6 via a keyed sleeve 18. The keyed sleeve 18 may define a diameter that is at least the defined diameter of the boring bar 6 so that the keyed sleeve 18 is configured to receive the boring bar 6 (e.g., similar to a pen cap fitting on a pen). In other embodiments of the invention, the clamp compound assembly 7 may be utilized in other ways to operatively couple the grinding assembly 7 to the end of the boring bar 6. Typically, the standard clamp compound assembly 17 serves as an additional interface between the grinding assembly 7 and the boring bar 6 for when a grind or a cut is to be completed with the grinding assembly 7 mounted on one end of the boring bar 6.

Additionally, the standard clamp compound assembly 17 may be adjustable via an axial compound feed system 19. The axial compound feed system 19 may include one or more threaded rods that may be used to adjust the standard clamp compound assembly 17 along the X-direction (e.g., in the direction of the boring bar 6 along the centerline of rotating machinery). As was previously described with respect to the grinding machine clamp 9 the clamp compound assembly 17 may be moveable in the in the Y-Z plane (e.g., along the length of the drive shaft sleeve 11). Thus, the adjustability of the standard clamp compound assembly 17 may enable the grinding assembly 7 to perform a wide range of differently-sized grinds or cuts.

In some embodiments, the present invention may be mounted in a substantially horizontal configuration so that the boring bar 6 runs along the X-axis. This configuration may enable the grinding assembly 7 to perform grinds or cuts in the Y-Z plane. In other embodiments the present invention may be mounted alone the Y-axis, such that the grinding assembly performs grinds or cuts in the X-Z plane. In other embodiments, the present invention may be mounted in a substantially vertical configuration so that the boring bar 6 runs along the Z-axis and grinds or cuts in the X-Y plane. The type of grind or cut to be made may determine the appropriate configuration, adjustment, or alignment required of the present invention. Various types of operations may require different combinations of the present invention's components to be used. In some embodiments, the present invention may be moveable via a forklift, a crane, or the like.

Adjustments or alignments of the present invention may be controlled via an air powered motor, a hydraulic motor, a computer control, CNC controls, an electrical motor, or manually. In some embodiments, the present invention may include electronic linear or rotary measuring equipment. In alternative embodiments, a linear position in conjunction with a depth or thickness gauge may be used to determine the depth of a grind or a cut to be made. This equipment may be incorporated into the adjustment components, the grinding assembly 7, or the like.

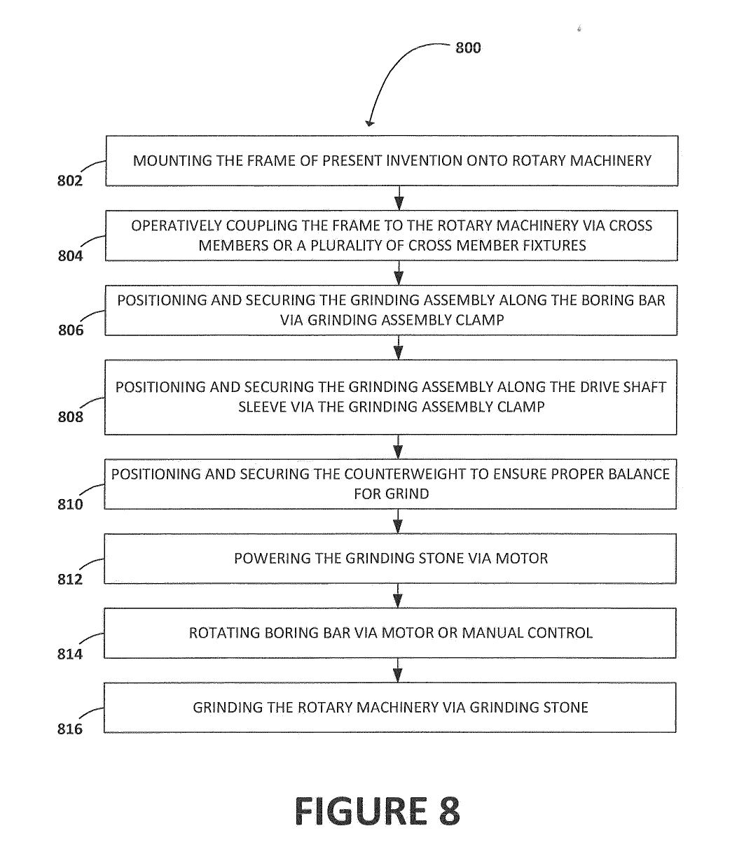

FIG. 8 illustrates a process flow 800 for executing a grinding operation using the present invention. At block 802 the process includes mounting the frame of the present invention onto a piece of rotary machinery. At block 804 the process includes operatively coupling the frame to the piece of rotary machinery via a plurality of adjustable feet coupled to each cross member. At block 806 the process includes positioning and securing the grinding assembly along the boring bar via the bar clamp. At block 808 the process includes positioning and securing the grinding assembly along the drive shaft sleeve via the grinding machine clamp and the radial compound advance. At block 810 the process includes positioning and securing the counterweight to ensure proper balance for the specific grinding operation. At block 812 the process includes powering the grinding stone via a motor, which may be electrically, hydraulically, computer-controlled air powered, or manually powered. At block 814 the process includes rotating the boring bar via a motor or a manual drive so that the grinding assembly rotates. At block 816 the process includes grinding the piece of rotary machinery via the grinding stone.

All in all, the present invention may enable the user to perform a myriad of operations with one device. Furthermore, the present invention may perform these operations onsite, perhaps eliminating the need for the equipment owner to ship large components offsite for repair or replacement. The present invention's adjustment and versatility of application may prove to save equipment owners substantial amounts of time and money as their equipment and equipment components wear and need repair over time. A wide variety of materials on a wide variety of equipment, machinery or the like may be ground, cut, or repaired by the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more.”

What is claimed is:

1. A portable grinding apparatus comprising:
a frame,
a boring bar operatively coupled to the frame; and
a grinding assembly operatively coupled to the boring bar, wherein the grinding assembly is adjustable in one or more axes by adjusting the frame or the grinding assembly for grinding a component secured to the frame.

2. The apparatus of claim 1, wherein the frame comprises a plurality of cross members that are substantially parallel to one another.

3. The apparatus of claim 2, wherein the cross members are steel I-beams.

4. The apparatus of claim 1, wherein the frame comprises adjustable feet.

5. The apparatus of claim 1, wherein the frame comprises a boring bar bearing fixture wherein the boring bar bearing feature is configured to receive the boring bar via a hole.

6. The apparatus of claim 5, wherein the frame comprises a plurality of collars that enable adjustment of the boring bar bearing feature along the cross member.

7. The apparatus of claim 1, wherein the boring bar is rotatable.

8. The apparatus of claim 7, wherein the rotation of the boring bar is driven by at least one of a hydraulic motor, an electric motor, an air powered motor, computer numerical controls (CNC), or a manual drive.

9. The apparatus of claim 1, wherein the grinding assembly comprises a bar clamp that couples the grinding assembly to the boring bar and enables adjustability of the grinding assembly along the axis of the boring bar.

10. The apparatus of claim 1, wherein the grinding assembly is axially adjustable via a grinding machine clamp that couples the grinding assembly to the bar clamp.

11. The apparatus of claim 1, wherein the grinding assembly includes at least one of an adjustable drive shaft, a counterweight, a grinding stone arbor, and a grinding stone.

12. The apparatus of claim 11, wherein the grinding stone includes live tooling.

13. The apparatus of claim 11, wherein the grinding stone is driven by at least one of a hydraulic motor, an air powered motor, an electric motor, computer numerical controls (CNC), or a manual drive.

14. The apparatus of claim 1, wherein the adjustments of the apparatus are powered by at least one of a hydraulic motor, an air powered motor, computer numerical controls, a manual drive, an electric motor, or electronic linear or rotary measuring equipment.

15. The apparatus of claim 1, wherein the grinding assembly is coupled to the boring bar via a keyed sleeve.

16. The apparatus of claim 1, wherein the grinding assembly includes a standard clamp compound assembly that is axially adjustable via an axial compound feed system.

17. The apparatus of claim 1, wherein the grinding assembly is configured at least one of linearly.

18. The apparatus of claim 1, wherein the grinding assembly is configured at a right angle.

19. The apparatus of claim 1, wherein the grinding assembly comprises at least one right angle gear drive.

20. A method of grinding a piece of rotary machinery, the method comprising:
mounting the frame of the present invention onto a piece of rotary machinery;
operatively coupling the frame to the piece of rotary machinery via a plurality of adjustable feet coupled to each cross member;
positioning and securing the grinding assembly along the boring bar via the bar clamp;
positioning and securing the grinding assembly along the drive shaft sleeve via the grinding machine clamp and the radial compound advance;
positioning and securing the counterweight to ensure proper balance for the specific grinding operation;
powering the grinding stone via a motor, which may be electrically, hydraulically, computer-controlled air powered, or manually powered;
rotating the boring bar via a motor or a manual drive so that the grinding assembly rotates; and
grinding the piece of rotary machinery via the grinding stone.
